(19) United States
(12) Patent Application Publication
(10) Pub. No.: US 2016/0296042 A1
(43) Pub. Date: Oct. 13, 2016

(54) Display System

(71) Applicant: Kate E. Mudge, San Clemente, CA (US)

(72) Inventor: Kate E. Mudge, San Clemente, CA (US)

(21) Appl. No.: 15/093,823

(22) Filed: Apr. 8, 2016

Related U.S. Application Data
(63) Continuation-in-part of application No. 29/523,649, filed on Apr. 13, 2015.
(60) Provisional application No. 62/146,497, filed on Apr. 13, 2015.

(51) Int. Cl. A47F 7/14; G09F 1/10; A47B 63/00; G09F 7/18; F16B 1/00; F16M 13/02

(52) U.S. Cl. CPC A47F 7/14; F16B 1/00; F16M 13/02; A47B 63/00; G09F 7/18; G09F 1/10; F16B 2001/0035

(57) ABSTRACT

A display system is provided, which comprises a customizable length display strap with a front surface, a back surface, a first end, and a second end, a connector strap with opposing first and second clips spaced apart by a length of elastic, and a plurality of fasteners. Additionally, a method is provided for displaying at least one two-dimensional item on a display structure.

### CROSS-REFERENCE TO RELATED APPLICATIONS

This application claims the benefit of Provisional Patent Application No. 62/146,497, filed on Apr. 13, 2015, which is hereby incorporated herein by reference. It is a continuation-in-part of U.S. patent application Ser. No. 29/523,649, filed on Apr. 13, 2015, which is hereby incorporated herein by reference.

### TECHNICAL FIELD

This invention relates generally to a display system for displaying two-dimensional items.

### BACKGROUND

Historically, the front surface of a refrigerator has often been used in homes as a display surface on which to secure two-dimensional items such as artwork, school work, report cards, certificates, greeting cards, invitations, photographs, newspaper and magazine clippings, recipes, notes and messages, advertisements, and the like.

These items have generally been secured to the refrigerator with magnets. However, stainless steel refrigerators commonly in use are generally not magnetic. Moreover, many people find the appearance of a clear, uncluttered refrigerator desirable. As such, alternative display areas and alternative means of securing such items to such display areas are often desirable.

Additionally, greeting cards, holiday greeting cards in particular, have generally transitioned from the majority being folded or tent-style cards, capable of standing upright on a shelf, mantel, or other ledge, to the majority being flat, two-dimensional cards. Thus, an alternative means of displaying such cards would also be desirable.

Conventional means of displaying two-dimensional items, such as the use of adhesive tape, reusable putty, thumbtacks, brads, nails, hole punches etc. often suffer because they can damage the display area and/or displayed item itself. Thus, it would be desirable to provide an alternative method of displaying two-dimensional items in a home or business. In particular, it would be desirable to provide a system whereby two-dimensional items could be easily displayed in a variety of display areas in the home or business, such displayed items could be easily changed, and it could be ensured that the display area and items themselves would not be damaged. The applicant has determined that existing approaches in these regards leave room for considerable improvement.

### BRIEF DESCRIPTION OF THE DRAWINGS

The above needs are at least partially met through provision of the display system described in the following detailed description, particularly when studied in conjunction with the drawings, wherein:

FIG. 1 comprises a perspective view of a display system configured in accordance with various embodiments of the invention;

FIG. 2 comprises a rear elevation view of the display system of FIG. 1;

FIG. 3 comprises a front elevation view of the display system of FIG. 1;

FIG. 4 comprises a left side elevation view of the display system of FIG. 1;

FIG. 5 comprises a right side elevation view of the display system of FIG. 1;

FIG. 6 comprises a top plan view of the display system of FIG. 1;

FIG. 7 comprises a bottom plan view of the display system of FIG. 1; and

FIG. 8 comprises a perspective view of the display system of FIG. 1 in a position of use with a cabinet.

Common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, these various embodiments comprise a display system. These teachings are highly flexible and scalable in practice and can serve to leverage a wide variety of existing display tools and/or methods.

Such a display system can facilitate the display of two-dimensional items such artwork, school work, report cards, certificates, greeting cards, invitations, photographs, newspaper and magazine clippings, recipes, notes and messages, advertisements, and the like, or combinations thereof. It addresses the need for such a system in homes or businesses where there is no magnetic-front refrigerator or where there is a desire to maintain a clear, uncluttered refrigerator. It provides a system whereby two-dimensional items can be easily displayed in a decorative and/or organized manner in a variety of display areas in a home or business, the displayed items can be easily changed, and it can be ensured that both the display area and displayed items themselves are not damaged in the display process. It also serves as a way to augment the usable area on which to display such items.

These and other benefits may become clearer upon making a thorough review and study of the following detailed description. Referring now to the drawings, various illustrative display systems that are compatible with many of these teachings will be presented.

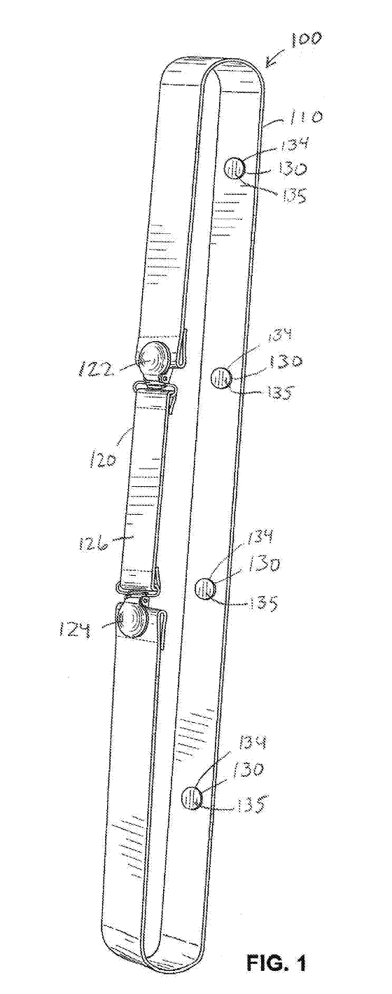

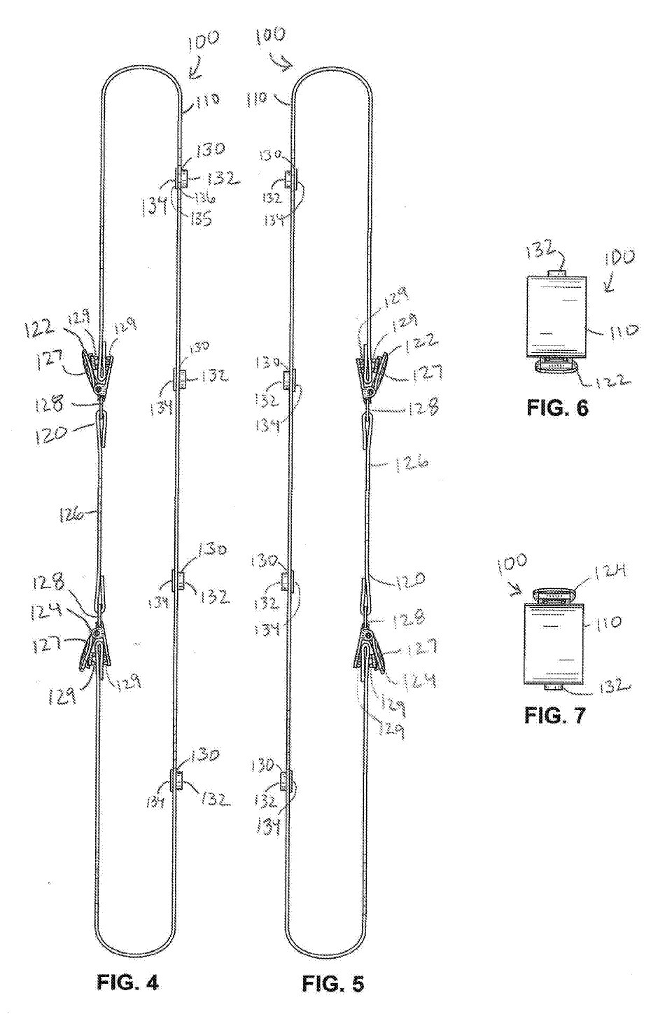

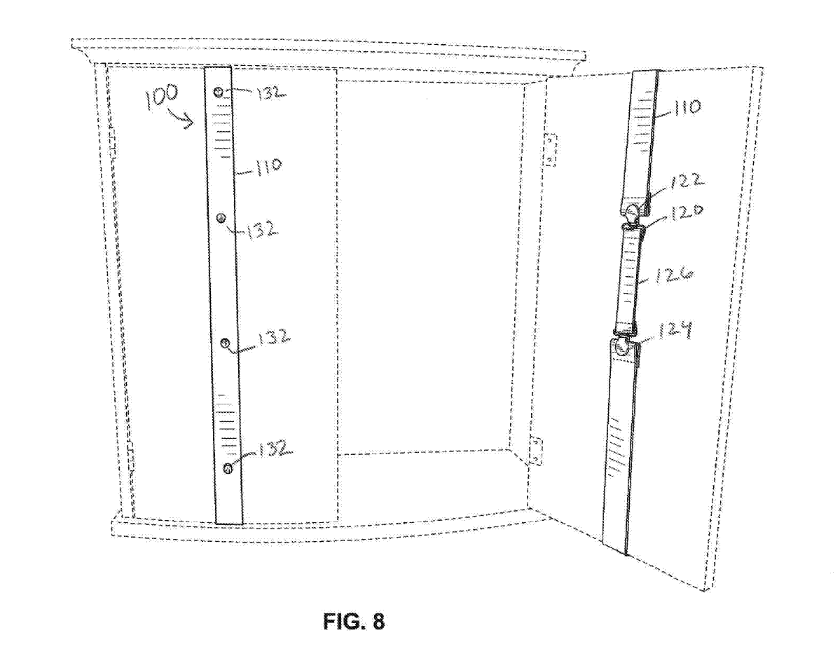

With reference to FIGS. 1-8, by one approach, a display system 100 is provided. The display system 100 includes a display strap 110, a connector strap 120 with opposing first and second clips 122, 124 spaced apart by a length of elastic 126, and a plurality of fasteners 130.

The display strap 110 comprises a customizable length, a front surface, a back surface, a first end, and a second end. In one form, the customizable length of the display strap 110 sufficient to wrap substantially around at least one dimension of a display structure, for example, a height or a width of the display structure.

In another form, display strap 110 comprises a customizable length sufficient to wrap substantially around a dimension of at least one of: a cabinet door, a closet door, an interior door, an exterior door, a hutch door, a vanity door, a desk door, an appliance door, an appliance, a window, a mirror, or other suitable display panel. In another form, the customizable length of the display strap 110 is initially in the range of approximately 4 feet to approximately 20 feet. The length can be customized to any desired length by cutting the strap or folding the strap over upon itself.

The display strap 110 can have any suitable width. In one form, the width is less than about 2 feet, preferably less than about 1 foot, more preferably, less than about 6 inches, and even more preferably, in the range of about 1.5 to about 2 inches.

In one form, the display strap 110 is configured to lay flat against a substantially flat display structure. The display strap 110 may be made of any suitable material, including but not limited to, ribbon, silk, cotton, polyester, burlap, acrylic, taffeta, linen, nylon, mesh, plastic, paper, metal, metal ribbon, metal sheeting and the like or combinations thereof.

The display strap 110 can have any suitable color or combination of colors. As will be readily understood by those of ordinary skill in the art, the word “color” refers herein to a visually perceptible property deriving from a spectrum of light including the categories of red, blue, yellow, etc. as well as categories of achromatic colors, such as white, black, and gray. The depiction of any specific color in the figures is for illustration only.

The display strap 110 can have any suitable pattern or combination of patterns, including but not limited to, solid colors, stripes, polka-dots, lattice, tie-dye, geometric shapes, rainbows, animal shapes, insect shapes, sports themes, team mascot shapes, holiday or seasonal images, and so forth. The depiction of any specific pattern in the figures is for illustration only.

The display strap 110 can have any suitable texture, including but not limited to smooth, woven, waffle, basket, pleated, ruched, and so forth, so long as the thickness of the display strap material does not prevent magnetic attraction therethrough.

The display strap 110 is preferably secured in place relative to the display structure by the connector strap 120. The connector strap 120 comprises a first clip 122 at a first end and a second clip 124 at an opposing second end. The first and second clips 122, 124 are spaced apart by a length of elastic 126.

The length of elastic 126 can be any suitable length. In one form, the length of elastic 126 less than or equal to approximately 2 feet, preferably less than or equal to approximately 1 foot, more preferably, less than or equal to approximately 6 inches.

Like the display strap 110, the first and second clips 122, 124 and length of elastic 126 of the connector strap 120 can have any suitable color, pattern, and/or texture. The depiction of any specific color, pattern, or texture is for illustration only.

In one form, the connector strap 120 is configured to secure the display strap 110 with either of the first or second clip 122, 124 of the connector strap fastening the first end of the display strap and the opposing clip 122, 124 fastening the second end of the display strap.

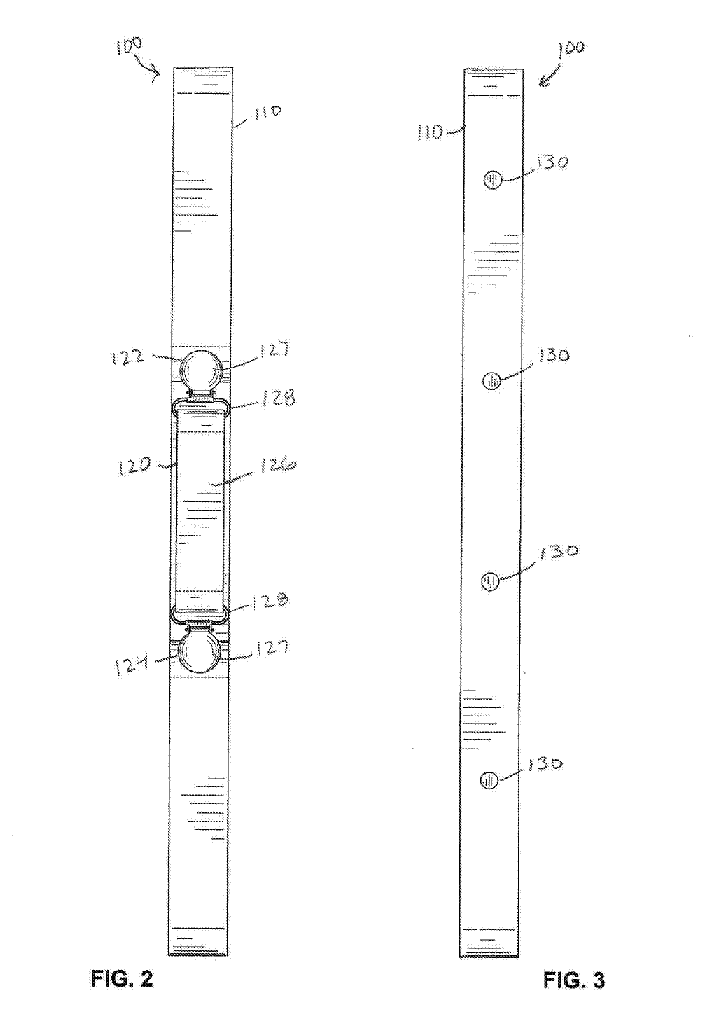

The first and second clip 122, 124 may be any suitable type of clip capable of fastening the ends of the display strap 110. As illustrated, for example, in FIGS. 2, 4 and 5, in one form, the first and second clip 122, 124 are suspender style clips with a face 127, a ring portion 128 for securing the clip to the length of 126, and a gripping portion 129 capable of closing down on the display strap 110. Face 127 can have any suitable color, shape, pattern, or texture. The depiction of any specific color, shape, pattern, or texture is for illustration purposes only.

With reference, for example, to FIGS. 3, 4 and 5, the plurality of fasteners 130 can be any suitable fastener capable of securing a two-dimensional item to the display strap 110. For example, the fasteners can include, but are not limited to, adhesive tape, reusable putty, thumbtacks, brads, nails, hole punches, safety pins, and the like.

In one preferred form, the plurality of fasteners 130 comprise a plurality of two-piece magnetic fasteners 131 each comprising a front member 132 and a back member 134. As will be readily understood by those of skill in the art, the front member 132 and back member 134 can be formed of any suitable material to provide a magnetic attraction between the members 132, 134. For example, in one form, the front and back members 132, 134 may both comprise a magnet. In another form, one of the front and back members 132, 134 comprises a magnet and the other comprises a ferromagnetic material.

The magnet may be made of any suitable material and have any suitable size for providing a magnetic attraction between the front and back members 132, 134 and securing a two-dimensional item therebetween. In one form, the magnet is a permanent magnet. In another form, the magnet is a neodymium magnet. In another form, the magnet is a neodymium magnet with a grade in the range of N35 to N52. In still another form, the magnet is cylindrical in shape and has diameter of less than about ½″ and a height of less than about ¼″.

As shown for example, in FIGS. 1, 4 and 5, in one form, the back member 134 comprises at least one substantially flat surface 135. In another form, the back member 134 comprises at least two substantially flat surfaces 135, 136. In still another form, the back member 134 is cylindrical with a height that is less than or equal to approximately 2 mm.

In a preferred form, the front member 132 comprises an ornamentation. The ornamentation can take any form, including for example, but not limited to, beads, gems, buttons, pictures, representations of sports equipment, flowers, coins, etc., and the like, and may be made of materials including, but not limited to, plastic, glass, fabric, wood, paper, stone, resin, acrylic, enamel, porcelain, ceramic, and the like.

In one form, the two-piece magnetic fastener 130 is configured to secure a two-dimensional item to the display strap 110 when the two-dimensional item and display strap are layered between the front member 132 and back member 134.

The substantially flat surface 135 of the back member 134 is configured to be positioned adjacent to a substantially flat surface of a display structure. In this regard, the two-piece magnetic fastener 130 is advantageously configured to inhibit any damage to the surface of the display structure.

In accordance with another aspect of the invention, a method is provided for displaying at least one two-dimensional item on a display structure having at least one substantially flat surface.

In accordance with the method, a display strap 110 having an customizable length, a front surface, a back surface, a first end, and a second end is arranged so that it is wrapped substantially around at least one dimension (e.g., height or width) of the display structure, with the back surface of the display strap adjacent to the substantially flat surface of the display structure. The display strap is secured in position relative to the display structure with a connector strap 120 having a first clip 122 and an opposing second clip 124, by fastening the first end of the display strap with the first clip 122 and fastening the second end of the display strap with the opposing second clip 124. The two-dimensional item is positioned over the front surface of the display strap in a layered arrangement and secured to the display strap with a two-piece magnetic fastener 130 having a front member 132 and a back member 134. In one form, the back member 134 is positioned behind the back surface of the display strap 110, in front of the substantially flat surface of the display structure, and the front member 132 is positioned in front of the two-dimensional item.

In another form, the substantially flat surface 135 of the back member 134 is positioned adjacent to a substantially flat surface of a display structure and thereby minimizes the risk of damage to the display structure.

In yet another form, the present method can be used to display a two-dimensional item on any variety of display structure including, for example, a cabinet door, a closet door, an interior door, an exterior door, a hutch door, a vanity door, a desk door, an appliance door, an appliance, a window, a mirror, or other display panel, and the like.

Those skilled in the art will recognize that the above described embodiments may be used with a wide variety of two-dimensional items, including but not limited to, artwork, school work, report cards, greeting cards, invitations, photographs, newspaper and magazine clippings, recipes, notes and messages, advertisements, and the like, or any combination thereof.

Further, those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

I claim:

1. A display system comprising:
a display strap comprising a customizable length, a front surface, a back surface, a first end, and a second end;
a connector strap comprising a first clip and an opposing second clip spaced apart by a length of elastic; and
a plurality of fasteners.

2. The display system of claim 1 wherein the plurality of fasteners comprises a plurality of two-piece magnetic fasteners, with each two-piece magnetic fastener comprising a front member and a back member.

3. The display system of claim 2 wherein the back member comprises at least one substantially flat surface.

4. The display system of claim 2 wherein the back member comprises at least two substantially flat surfaces.

5. The display system of claim 2 wherein the back member comprises a cylinder with a height that is less than or equal to approximately 2 mm.

6. The display system of claim 2 wherein the front member comprises an ornamentation.

7. The display system of claim 2 wherein the two-piece magnetic fastener is configured to secure a two-dimensional item to the display strap when the two-dimensional item and display strap are layered between the back member and the front member.

8. The display system of claim 2, wherein the two-piece magnetic fastener comprises a neodymium magnet.

9. The display system of claim 1 wherein the display strap comprises at least one of: ribbon, silk, cotton, polyester, burlap, acrylic, taffeta, linen, nylon, mesh, plastic, paper, metal, metal ribbon, metal sheeting, and combinations thereof.

10. The display system of claim 1 wherein the customizable length is sufficient to wrap the display strap substantially around a dimension of a display structure.

11. The display system of claim 1 wherein the customizable length is sufficient to wrap the display strap substantially around a dimension of at least one of: a cabinet door, a closet door, an interior door, an exterior door, a hutch door, a vanity door, a desk door, an appliance door, an appliance, a window, a mirror, and a display panel.

12. The display system of claim 1 wherein display strap is secured in place relative to the display structure by the connector strap, with the first clip fastening the first end of the display strap and the opposing second clip fastening the second end of the display strap.

13. A method of displaying at least one two-dimensional item on a display structure having at least one substantially flat surface, the method comprising the steps of:
arranging a display strap having an customizable length, a front surface, a back surface, a first end, and a second end substantially around a dimension of the display structure, with the back surface of the display strap adjacent to the substantially flat surface of the display structure;
securing the display strap in position relative to the display structure with a connector strap having a first clip and an opposing second clip spaced apart by a length of elastic, by fastening the first end of the display strap with the first clip and fastening the second end of the display strap with the opposing second clip;
positioning the two-dimensional item over the front surface of the display strap in a layered arrangement; and
securing the two-dimensional item to the display strap with a fastener.

14. The method of claim 13, wherein securing the two-dimensional item to the display strap with a fastener comprises securing the two-dimensional item to the display strap with a two-piece magnetic fastener having a front member and a back member, by positioning the back member behind the back surface of the display strap, in front of the substantially flat surface of the display structure, and positioning the front member in front of the two-dimensional item.

15. The method of claim 14 wherein the back member comprises at least one substantially flat surface.

16. The method of claim 14 wherein the back member comprises at least two substantially flat surfaces.

17. The method of claim 14 wherein the back member comprises a cylinder with a height that is less than or equal to approximately 2 mm.

18. The method of claim 14 wherein the front member comprises an ornamentation.

19. The method of claim 14 wherein the two-piece magnetic fastener comprises a neodymium magnet.

20. The method of claim 13 wherein the display strap comprises at least one of: ribbon, silk, cotton, polyester, burlap, acrylic, taffeta, linen, nylon, mesh, plastic, paper, metal, metal ribbon, metal sheeting, and combinations thereof.
